(19) United States
(12) Patent Application Publication
(10) Pub. No.: US 2015/0092526 A1
(43) Pub. Date: Apr. 2, 2015

(54) MULTI-LAYER OPTICAL RECORDING MEDIUM AND OPTICAL RECORDING DEVICE

(71) Applicant: TAIYO YUDEN CO., LTD., Taito-ku, Tokyo (JP)

(72) Inventors: Kenichi Shimomai, Takasaki-shi (JP); Yutaka Imamura, Takasaki-shi (JP)

(73) Assignee: TAIYO YUDEN CO., LTD., Taito-ku, Tokyo (JP)

(21) Appl. No.: 14/388,686

(22) PCT Filed: Mar. 21, 2013
(86) PCT No.: PCT/JP2013/057955

§ 371 Date: Sep. 26, 2014

(30) Foreign Application Priority Data
Mar. 30, 2012 (JP) 2012081273

(51) Int. Cl. G11B 7/007; G11B 7/24038

(52) U.S. Cl. CPC G11B 7/00736; G11B 7/24038
USPC 369/47.49; 369/275.3

(57) ABSTRACT

A multi-layer recording medium is constituted by guide layer-equipped optical disks having a plurality of recording layers and guide layers are integrated by bonding said disks to one another so as to produce a double-sided disk, both sides of which may be used for recording. With regards to the lead-in areas for the guide layers of the guide layer-equipped optical disks for both sides, single-sided disks and double-sided disks are identified, and face-management information for identifying the side surfaces in the case of a double-sided disk is recorded in advance in said lead-in areas using wobbles or the like. As a result, the likelihood of the occurrence of defective products caused by the inability to read the face information can be reduced.

### TECHNICAL FIELD

The present invention relates to an optical recording medium with guide layer having a guide layer and multiple recording layers, as well as a multi-layer optical recording medium and optical recording device that records information to this optical recording medium with guide layer.

### BACKGROUND ART

DVDs (digital versatile disk), Blu-ray Discs (registered trademark) and other optical disks are produced with multiple recording layers to increase their capacity. To support multiple recording layers, methods are known whereby guide tracks provided in layers different from the recording layers are used to perform tracking control when data is recorded to or played back from the recording layers. For example, optical drive devices, etc., are available that use light of 390 nm to 420 nm in wavelength (blue) to perform tracking control through a guide track layer having grooved guide tracks, while using light of 650 nm to 680 nm in wavelength (red) to record information to one of the multiple recording layers (refer to Patent Literature 1, etc., for example).

Furthermore, methods are also known to simultaneously record or read data to/from multiple recording layers provided on an optical disk using multiple optical pickups, in order to improve the data transfer speed. For example, devices, etc., are known that use two optical pickups to simultaneously record and play back information to/from a recording layer on the top side of the disk and another recording layer on the bottom side of the disk based on the CLV (constant linear velocity) method (refer to Patent Literature 2, etc., for example).

Optical disks are also available that permit recording and playback of information to/from both sides, with identification information of sides A and B recorded using pre-pits in the lead-in areas on the respective recording sides. When a recording medium is inserted into a drive device with its sides A and B reversed, identification information of sides A and B allows the drive device to recognize that the recording medium has been inserted wrongly (refer to Patent Literature 3, etc., for example).

### PRIOR ART LITERATURES

### Patent Literatures

Patent Literature 1: Japanese Patent Laid-open No. 2007-200427
Patent Literature 2: Japanese Patent Laid-open No. Hei 1-134766
Patent Literature 3: Japanese Patent Laid-open No. Hei 2000-251387

### SUMMARY OF THE INVENTION

### Problems to Be Solved by the Invention

When considering an optical recording device which is capable of, using two optical pickups, simultaneously recording information to both sides of a double-sided disk having multiple recording layers on both sides, it is necessary to record face information to the recording layers on both sides of the optical disk in order to identify the respective sides, so that correlations between the respective sides of the optical disk and the two optical pickups can be set to the optical recording device. At this time, the face information must be recorded to all of the multiple recording layers on both sides using pre-pits, etc. As the number of stacked recording layers increases, however, having to record the face information and other management information to the recording layers using pre-pits, etc., increases the incidence of defects caused by unreadable management information. This has been considered one factor that is driving up the prices of recording media products.

In addition, for an optical recording device to support both double-sided disks and single-sided disks having recording layers only on one side, it is necessary to install single-sided disk determination algorithms, etc., including algorithms to determine tracking lead-in failures and other errors, in the optical recording device. However, such single-sided disk determination algorithms take time to make a determination due to a need for repeated processes such as tracking lead-in retries, which can lead to a drop in response.

In light of the situations mentioned above, the object of the present invention is to provide a multi-layer optical recording medium and optical recording device that can prevent the manufacturing yield from dropping due to unreadable management information, while allowing for quick discrimination of double-sided disks and single-sided disks.

### Means for Solving the Problems

To achieve the aforementioned object, the multi-layer optical recording medium pertaining to an embodiment of the present invention comprises two optical recording media with guide layers, each medium having multiple recording layers capable of recording information as well as a guide layer having guide tracks for tracking and a lead-in area where management information is pre-recorded along the guide tracks, where such two optical recording media with guide layers are integrally attached together in a manner constituting a double-sided disk capable of recording information on both sides, and the management information includes face-identification information for identifying the sides of the double-sided disk.

The multi-layer optical recording medium pertaining to the present invention, which has management information including face-identification information for identifying the sides of a double-sided disk pre-recorded in the lead-in area of its guide layer, can lower the incidence of defects caused by unreadable face information, thereby improving the manufacturing yield, compared to when the face-management information is recorded to the recording layers using pre-pits, etc.

The optical recording device pertaining to another embodiment of the present invention is an optical recording device capable of recording information to a multi-layer optical recording medium, which comprises two optical recording media with guide layers, each medium having multiple recording layers capable of recording information as well as a guide layer having guide tracks for tracking and a lead-in area where management information is pre-recorded along the guide tracks, where such two optical recording media with guide layers are integrally attached together in a manner constituting a double-sided disk capable of recording information on both sides, and the management information includes face-identification information for identifying the sides of the double-sided disk; wherein such optical recording device comprises: a first optical pickup provided in correspondence with one of the optical recording media with guide layers constituting the multi-layer optical recording medium, and having a first guide optical system that condenses a first guide light onto the guide layer of the one optical recording medium with guide layer and then receives the reflection of the condensed light; a second optical pickup provided in correspondence with the other optical recording medium with guide layer constituting the multi-layer optical recording medium, and having a second guide optical system that condenses a second guide light onto the guide layer of the other optical recording medium with guide layer and then receives the reflection of the condensed light; a management information playback part that plays back based on the first guide light received by the first guide optical system, as first management information, the management information recorded in the guide layer of the one multi-layer recording medium with guide layer, and also plays back based on the second guide light received by the second guide optical system, as second management information, the management information recorded in the guide layer of the other multi-layer recording medium with guide layer; and a control part that sets correlations between the first optical pickup and second optical pickup on one hand, and the sides of the double-sided disk on the other, based on the face-identification information included in the first management information and second management information, respectively, that have been played back.

According to the optical recording device pertaining to the present invention, first management information and second management information that respectively include face-identification information for identifying the sides of a double-sided disk can be read from the lead-in areas of the guide layers of the optical recording media with guide layers on both sides of the double-sided disk. In addition, since the control part sets correlations between the first optical pickup and second optical pickup on one hand, and the sides of the double-sided disk on the other, based on the face-identification information included in the first management information and second management information, there is no limitation as to the orientation of a double-sided disk, or whether its top or bottom side faces up/down, when the disk is set in the optical recording device.

The optical recording device pertaining to the present invention may be such that either a first multi-layer optical recording medium being the aforementioned multi-layer optical recording medium, or a second multi-layer optical recording medium being the multi-layer optical recording medium where the optical recording medium with guide layer is used alone as a single-sided disk capable of recording information to one side and the management information includes single-sided disk-identification information for identifying the single-sided disk, can be selectively set and, when the second multi-layer optical recording medium is set, then the face-management information playback part plays back the management information based on the guide light received by one of the first optical pickup and second optical pickup, while the control part stops the operation of the other optical pickup between the first optical pickup and second optical pickup based on the single-sided disk-identification information included in the management information that has been played back.

This way, a single-sided disk can be determined more quickly and reliably compared to the method of determining a single-sided disk based on tracking lead-in failures and other errors, thereby shortening the time after a single-sided disk is loaded until recording of user data to the single-sided disk is actually started.

### Effects of the Invention

As mentioned above, the present invention can prevent the manufacturing yield from dropping due to unreadable management information, while allowing for quicker discrimination of double-sided disks and single-sided disks.

### BRIEF DESCRIPTION OF THE DRAWINGS

FIG. 1 A drawing showing an optical recording system pertaining to an embodiment of the present invention.

FIG. 2 A drawing showing the structure of the storage unit, disk cartridges and drive unit of the optical recording system in FIG. 1.

FIG. 3 A section view showing the structure of an optical recording medium with guide layer.

FIG. 4 A drawing showing the structure of the areas, as divided according to positions in the radial direction, of the guide layer and recording layer of the optical recording medium with guide layer.

FIG. 5 A drawing showing the structure of the disk drive of the optical recording system in FIG. 1.

FIG. 6 A flow chart showing a procedure according to which the disk drive in FIG. 4 performs control based on face-management information.

FIG. 7 A drawing showing a condition where double-sided disks are set, in the same orientation in terms of whether the top or bottom side (side A or B) faces up/down, in the respective disk drives of the drive unit.

FIG. 8 A drawing explaining how, when double-sided disks are set in the drive unit, any limitation as to their orientation, or whether their top or bottom side faces up/down, is eliminated.

### MODE FOR CARRYING OUT THE INVENTION

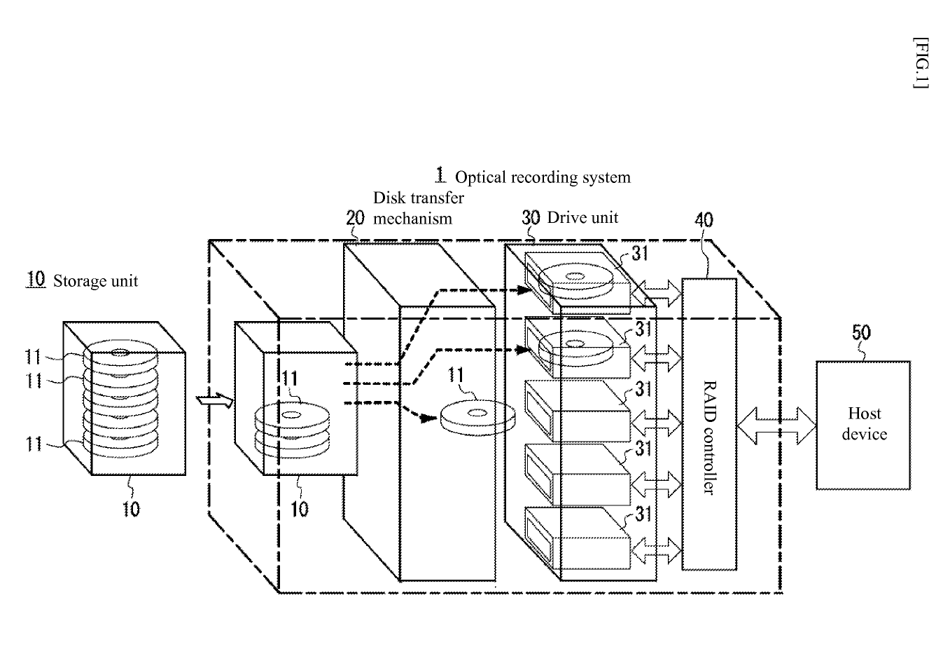

The following explains an embodiment of the present invention by referring to the drawings. FIG. 1 is a drawing showing an optical recording system pertaining to an embodiment of the present invention.

FIG. 1 is a drawing showing the overall structure of the optical recording system. This optical recording system 1 has a storage unit 10, disk transfer mechanism 20, drive unit 30, RAID controller 40, and host device 50. Their details are explained below.

[Storage 10] The storage unit 10 is a unit that accommodates multiple optical disks 11, which are multi-layer optical recording media, in a separately and freely settable/removable manner.

Multiple optical disks 11 are assumed to be stacked flat, arranged in the vertical direction or laid out in other arrangements as they are accommodated in the storage unit 10. In any case, preferably a specified clearance is provided between a pair of adjacent optical disks 11 so that the optical disks 11 can be smoothly loaded and removed into/from the storage unit 10. The storage unit 10 is assumed to have, for example, a rectangular solid, cylinder, or other shape from the viewpoints of ease of handling by the user, storage efficiency of optical disks 11, and so on. In the example in FIG. 1, a rectangular solid storage unit 10 accommodating multiple optical disks 11 stacked flat is used.

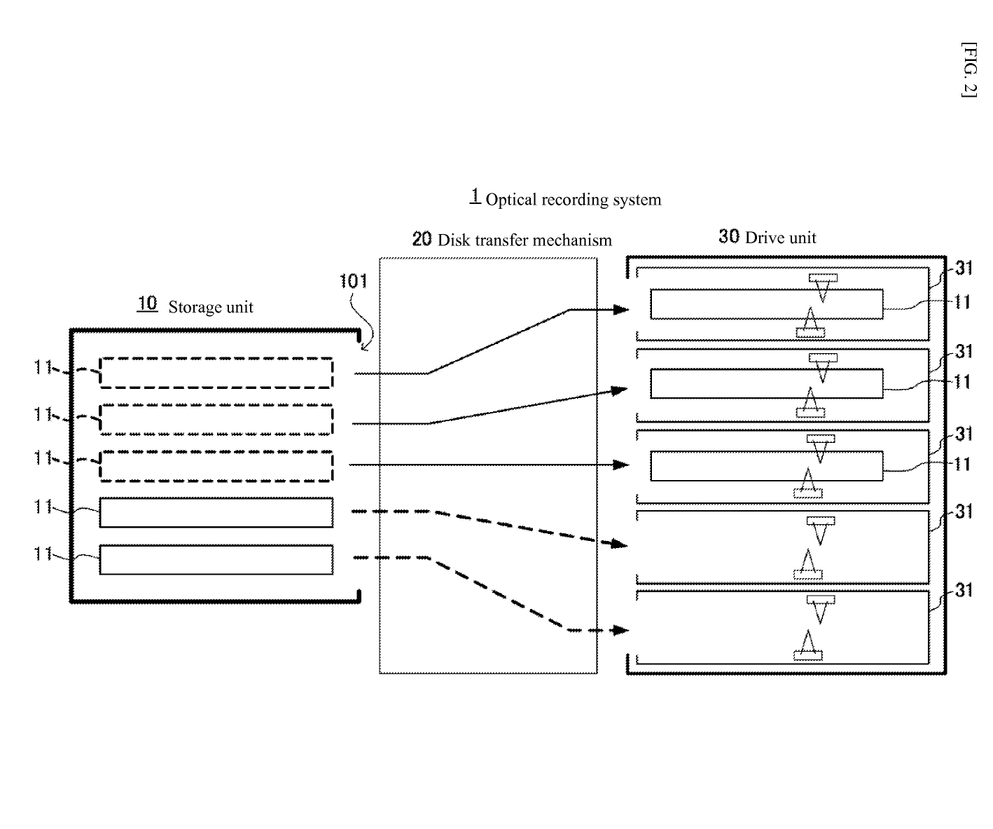

FIG. 2 is a drawing showing the structure of the storage unit 10, optical disks 11 and drive unit 30. At least one side face of the storage unit 10 has an opening 101 through which to load and remove optical disks 11, as well as a door (not illustrated) that opens and closes the opening 101. The door opens and closes in conjunction with the loading and removal of optical disks 11 into/from the storage unit 10 by the disk transfer mechanism 20, and remains closed at all other times.

It should be noted that, under the present invention, the structure of the storage unit 10 is not limited to the one shown in FIG. 2. Many variations are possible in terms of the shape of the storage unit 10, number and location of openings, whether or not a door is provided, arrangement in which multiple optical disks 11 are accommodated, and so on.

[Optical Disk 11] The optical disk 11 accommodated in the storage unit 10 is a so-called “optical disk with guide layer” having its guide layer and recording layer formed separately as different layers. Particularly in this embodiment, double-sided recording optical disks each comprising two optical disks with guide layers attached together, and single-sided recording optical disks each using an optical disk with guide layer alone, are used. The double-sided recording optical disk and single-sided recording optical disk are hereinafter referred to as the “double-sided disk” and “single-sided disk,” respectively.

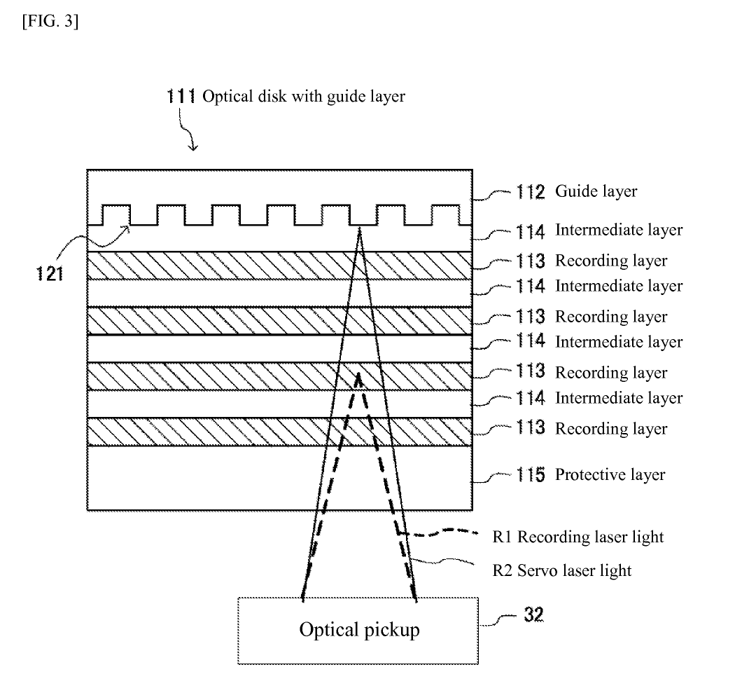

FIG. 3 is a section view showing the structure of an optical disk with guide layer 111. The optical disk with guide layer 111 has a guide layer 112 and multiple recording layers 113. In the example of the optical disk with guide layer 111 in this figure, the number of recording layers 113 is 4. An intermediate layer 114 having optical transparency is inserted between the guide layer 112 and the recording layer 113 closest to it, and also between a pair of adjacent recording layers 113. These layers are stacked and arranged in the following order, from the side where the recording playback light R1 and guide light R2 from an optical pickup 32 enter: a protective layer 115, the recording layer 113, intermediate layer 114, recording layer 113, intermediate layer 114, recording layer 113, intermediate layer 114, recording layer 113, intermediate layer 114, and guide layer 112.

On the side of the guide layer 112 facing the recording layer 113, guide tracks 121 of land/groove structure are provided for tracking control in a spiral or concentric circle pattern. On the sidewalls of guide tracks 121, physical address information indicating the track position information all around the disk is formed by means of wobble modulation. The guide tracks 121 are formed, for example, at a track pitch (0.64 μm) corresponding to the red laser light used for recording and playback of information to/from DVDs (digital versatile disks). The average pitch between the land and groove is 0.32 μm. This red laser light is hereinafter referred to as the “guide light.”

The optical recording system 1 in this embodiment performs tracking control in both the lands and grooves of guide tracks 121 using the differential push-pull (DPP) method, for example. Performing tracking control in both the lands and grooves of guide tracks 121 allows information to be recorded to the recording layer 113 at a track pitch of 0.32 μm.

The recording layer 113 is a layer to which information is recorded, for example, at a track pitch (0.32 μm) corresponding to the blue laser light used for recording and playback of information to/from Blu-ray Discs (registered trademark). This blue laser light is hereinafter referred to as the “recording/playback light” or “recording light.” The recording layer 113 comprises an optical absorption layer, reflection layer, etc., for example. For the optical absorption layer, cyanine pigments, azo pigments, and other organic pigments, or Si, Cu, Sb, Te, Ge, and other inorganic materials, are used. When the recording light is irradiated onto the target recording layer 113 of the optical disk with guide layer 111, the area irradiated by the recording light changes its reflectivity and this area whose reflectivity has changed is formed as a pit, and information is recorded to the recording layer 113 as a result.

Because tracking control and acquisition of physical address and reference clock are performed using the guide tracks 121 on the guide layer 112 when information is recorded and played back to/from the recording layer 113, no guide tracks 121 of land/groove structure are required on the recording layer 113. Accordingly, the recording layer 113 can have a flat surface.

The optical disk 11 being a double-sided disk is constituted by two optical disks with guide layer 111 integrally attached together, with the non-land/groove-structure sides of their guide layers 112 facing each other.

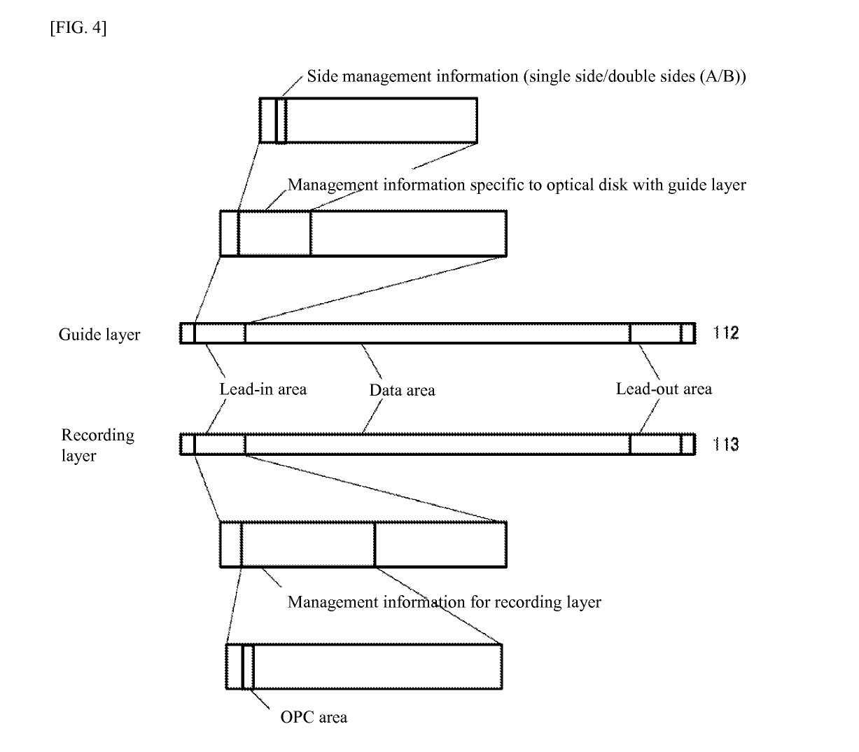

FIG. 4 is a drawing showing the structure of the areas, as divided according to positions in the radial direction, of the guide layer 112 and recording layer 113 of the optical disk with guide layer 111. The guide layer 112 and recording layer 113 are each divided in the same way into a lead-in area, data area, and lead-out area, from the inner periphery side, according to positions in the radial direction.

In the lead-in area of the guide layer 112, management information specific to the optical disk with guide layer 111 is pre-recorded by means of wobble modulation, etc. The management information specific to the optical disk with guide layer 111 includes face-management information that identifies whether the optical disk with guide layer 111 alone constitutes a single-sided disk, or whether it constitutes a double-sided disk, and also identifies, when the optical disk with guide layer 111 constitutes a double-sided disk, whether it represents the top or bottom side (side A or B) of the double-sided disk. The face-management information included in the management information of a double-sided disk is also referred to as the “face-identification information” in that it is used to identify the sides. On the other hand, the face-management information included in the management information of a single-sided disk is also referred to as the “single-sided disk identification information” in that it is used to identify a single-sided disk.

The management information specific to the optical disk with guide layer 111 may include, in addition to the aforementioned face-management information, the number of recording layers in the optical disk with guide layer 111, recording method, recording line speed, laser power and laser driving pulse waveforms used for recording and playback, and other recommended information, as well as position information in the data area, etc.

In the data area of the guide layer 112, physical address and other information assigned to the data area are pre-recorded by means of wobble modulation of guide track 121 grooves, etc. The same information recorded to the lead-in area can also be pre-recorded to the lead-out area of the guide layer 112 by means of wobble modulation, etc.

The lead-in area of the recording layer 113 is an area where management information used for recording and playback to/from the recording layer 113 is recorded by means of a pit array. The management information used for recording and playback to/from the recording layer 113 includes the layer number assigned to the recording layer 113 and other layer information, replacement management information relating to replacement of defective areas, optimal laser power for recording and playback and other recording/playback conditions, etc. The recording/playback conditions are determined by the disk drive 31 test-recording information to an area (OPC area) in the lead-in area and then evaluating the result.

[Disk Transfer Mechanism 20] The disk transfer mechanism 20 is a mechanism for removing a target optical disk 11 from the storage unit 10 and loading it into a disk drive 31 in the drive unit 30, as well as returning to the storage unit 10 an optical disk 11 ejected from a disk drive 31.

Ideally the disk transfer mechanism 20 has multiple transfer mechanisms that are independently operable so that multiple optical disks 11 can be removed simultaneously from the storage unit 10 and loaded separately into multiple disk drives 31 in the drive unit 30, for example.

[Drive Unit 30] Multiple disk drives 31 are installed in the drive unit 30. In the example in this figure, five disk drives 31 are installed. The number of optical disks 11 accommodated in the storage unit 10 need not be the same as the number of disk drives 31 installed in the drive unit 30.

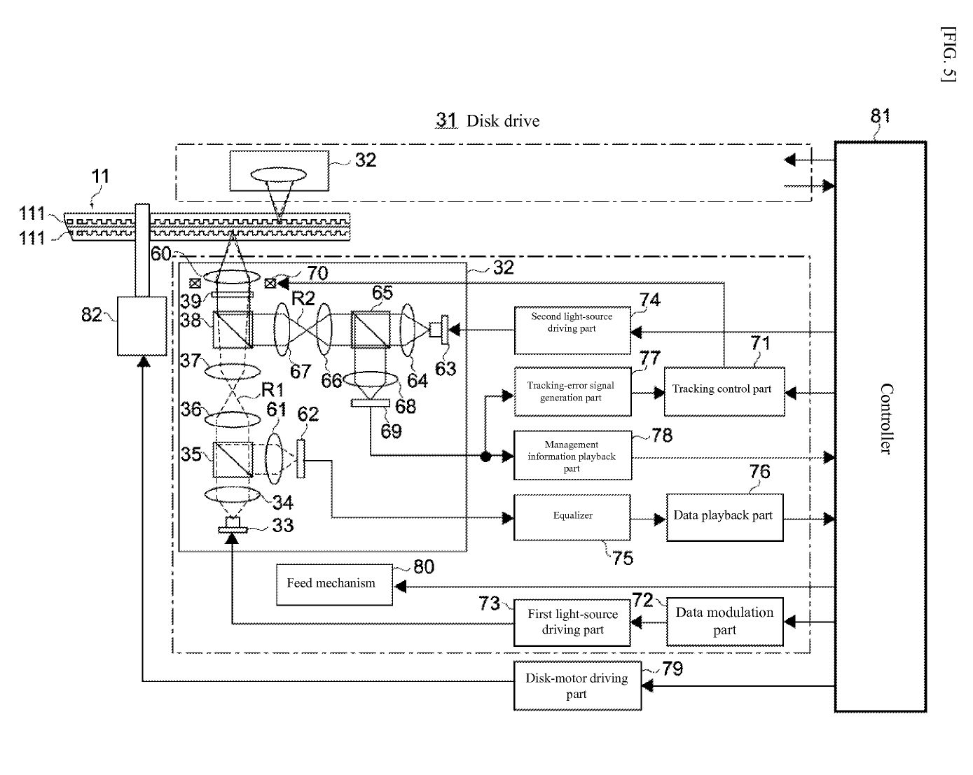

(Structure of Disk Drive 31) FIG. 5 is a drawing showing the structure of the disk drive 31 constituting an optical recording device. This disk drive 31 has an optical pickup 32. The optical pickup 32 has a recording/playback optical system corresponding to the recording/playback light, and a guide optical system corresponding to the guide light.

The recording/playback optical system comprises a first light source 33, first collimator lens 34, first polarizing beam splitter 35, first relay lens 36, second collimator lens 37, synthesizing prism 38, ¼ wavelength plate 39, objective lens 60, first light-receiving lens 61, and first light-receiving part 62, among others. Here, the synthesizing prism 38, ¼ wavelength plate 39 and objective lens 60 belong to both the recording/playback optical system and the guide optical system explained later.

The first light source 33 has a laser diode that emits laser light of a first wavelength as the recording/playback light R1. The recording/playback light R1 emitted from the first light source 33 is converted to parallel rays of light by the first collimator lens 34 and enters the synthesizing prism 38 as such via the first polarizing beam splitter 35, first relay lens 36, and second collimator lens 37. The synthesizing prism 38 synthesizes the recording/playback light R1 entering from the second collimator lens 37 with the guide light R2 of a second wavelength as it enters from a third collimator lens belonging to the guide optical system explained later, in such a way that their respective optical axes are matched with each other, and causes the synthesized light to enter the objective lens 60 via the ¼ wavelength plate 39. The objective lens 60 condenses the entering recording/playback light so that it focuses onto the target recording layer 113 (FIG. 3) of one optical disk with guide layer 111 of the optical disk 11 being a double-sided disk.

The recording/playback light (return light) that has been reflected by the recording layer 113 enters the synthesizing prism 38 via the objective lens 60 and ¼ wavelength plate 39 and then transmits through the synthesizing prism 38 in the same direction in which it entered the prism, to return to the first polarizing beam splitter 35 via the second collimator lens 37 and first relay lens 36. The first polarizing beam splitter 35 reflects at an angle of approx. 90 degrees the return light of the first wavelength from the first relay lens 36, thereby causing it to enter the first light-receiving part 62 via the first light-receiving lens 61.

The first light-receiving part 62 has a light-receiving element whose light-receiving surface is divided vertically and laterally into a total of four sections, for example, and outputs, as a playback signal, a voltage signal of a level according to the light-receiving intensity of the light-receiving surface of each section.

The guide optical system (first guide optical system, second guide optical system) each comprises a second light source 63, third collimator lens 64, second polarizing beam splitter 65, second relay lens 66, fourth collimator lens 67, synthesizing prism 38, ¼ wavelength plate 39, objective lens 60, second light-receiving lens 68, and second light-receiving part 69, etc.

The second light source 63 emits the guide light R2 being the red laser light. The guide light R2 emitted from the second light source 63 is converted to parallel rays of light by the third collimator lens 64 and enters the synthesizing prism 38 as such via the second polarizing beam splitter 65, second relay lens 66, and fourth collimator lens 67. As mentioned above, the guide light R2 entering the synthesizing prism 38 is synthesized through the synthesizing prism 38 with the recording/playback light R1 of the first wavelength entering from the second collimator lens 37 of the recording/playback optical system, in such a way that their respective optical axes are matched with each other, and the synthesized light is caused to enter the objective lens 60 via the ¼ wavelength plate 39. The objective lens 60 condenses the entering guide light R2 so that it focuses onto the guide layer 112 (FIG. 3) of the other optical disk with guide layer 111 of the optical disk 11 being a double-sided disk.

The guide light R2 (return light) that has been reflected by the guide layer 112 enters the synthesizing prism 38 via the objective lens 60 and ¼ wavelength plate 39 and then is reflected by the synthesizing prism 38 at an angle of approx. 90 degrees, to return to the second polarizing beam splitter 65 via the fourth collimator lens 67 and second relay lens 66. The second polarizing beam splitter 65 reflects at an angle of approx. 90 degrees the return light of the guide light R2 from the second relay lens 66, thereby causing it to enter the second light-receiving part 69 via the second light-receiving lens 68.

The second light-receiving part 69 has a light-receiving element whose light-receiving surface is divided vertically and laterally into a total of four sections, for example, and outputs, as a playback signal, a voltage signal of a level according to the light-receiving intensity of the light-receiving surface of each section.

In addition, the optical pickup 32 has a tracking actuator 70 and focusing actuator (not illustrated) provided in it. The tracking actuator 70 moves the objective lens 60, under the control of a tracking control part 71, in the radial direction of the disk corresponding to the direction vertical to the optical axis. The focusing actuator moves the objective lens 60 in the direction of the optical axis under the control of a focus control part not illustrated herein.

Also provided in the optical pickup 32, although not illustrated, are a first relay lens actuator that moves the first relay lens 36 in the direction of the optical axis in a manner switching the recording layer 113 to be irradiated by the recording/playback light, and a second relay lens actuator that moves the second relay lens 66 in the direction of the optical axis. The foregoing provides an explanation of the optical pickup 32.

The disk drive 31 has, in addition to the optical pickup 32 above, a data modulation part 72, first light-source driving part 73, second light-source driving part 74, equalizer 75, data playback part 76, tracking-error generation part 77, tracking control part 71, management information playback part 78, disk-motor driving part 79, feed mechanism 80, controller 81, as well as focus control part and relay lens control part not illustrated herein, etc.

The data modulation part 72 modulates the recording data supplied from the controller 81, and supplies modulation signals to the first light-source driving part 73.

The first light-source driving part 73 uses the modulation signals from the data modulation part 72 to generate driving pulses for driving the first light source 33.

The equalizer 75 generates binary signals by applying PRML (partial response maximum likelihood) or other equalizing process, for example, to the playback RF signals from the first light-receiving part 62.

The data playback part 76 demodulates data from the binary signals output by the equalizer 75, performs error correction and other decoding processes based on the demodulated data to generate playback data, and supplies the data to the controller 81.

The tracking-error generation part 77 generates tracking error signals based on the output of the second light-receiving part 69 using the differential push-pull method, for example, and supplies the signals to the tracking control part 71.

The tracking control part 71 controls the tracking actuator 70 based on the tracking error signals from the tracking-error generation part 77, and moves the objective lens 60 in the direction vertical to the optical axis, to perform tracking control.

The management information playback part 78 plays back the management information that has been modulated into wobble, for example, based on the output of the second light-receiving part 69, and supplies the information to the controller 81.

The disk-motor driving part 79 supplies driving signals, under control by the controller 81, to the disk motor 82 that rotates and drives the optical disk 11.

The feed mechanism 80 is a mechanism that transfers the optical pickup 32 in the radial direction of the optical disk 11.

The focus control part not illustrated herein drives the focusing actuator not illustrated herein to move the objective lens 60 in the direction of the optical axis.

The controller 81 (control part) has a CPU (central processing unit), ROM (read only memory) and RAM (random access memory), etc. The controller 81 controls the disk drive 31 as a whole based on the program loaded into the main memory area assigned to the RAM.

The drive unit 30 has multiple disk drives 31 of the above description installed in it and allows them to be controlled independently, so that information can be recorded and played back to/from the loaded optical disks 11 separately but simultaneously.

The optical recording system 1 in this embodiment is assumed to support double-sided disks, and therefore each disk drive 31 has one optical pickup 32 corresponding to one side (top side) of the optical disk 11 and another corresponding to the other side (bottom side), arranged as a first optical pickup (including the first guide optical system) and second optical pickup (including the second guide optical system), respectively, and the data modulation part 72, first light-source driving part 73, second light-source driving part 74, equalizer 75, data playback part 76, tracking-error generation part 77, tracking control part 71, management information playback part 78, feed mechanism 80, focus control part, relay lens control part, etc., are provided in correspondence with each optical pickup 32. The controller 81 is made to control the aforementioned two systems altogether.

[RAID Controller 40] The RAID (redundant array of inexpensive disks) controller 40 performs RAID control that involves recording data redundantly to one or more disk drives 31 in the drive unit 30, or recording data in a distributed manner by means of striping, in response to a recording command, etc., from the host device 50.

The controller 81 of each disk drive 31 to which a recording or playback instruction has been given from the RAID controller 40, performs controls for recording or playing back data to/from the optical disks with guide layer 111 on both sides of the optical disk 11.

[Host Device 50] The host device 50 is the highest-level device that controls this optical recording system 1. The host device 50 may be a personal computer. The host device 50 creates or prepares recording data, and supplies to the RAID controller 40 a recording command for the recording data. The host device 50 also supplies the RAID controller 40 with a readout command including a user-specified file name, and obtains as a response the data of the applicable file name provided.

[Operation of Optical Recording System 1]

Next, an example of how the disk drive operates using the aforementioned face-management information is explained.

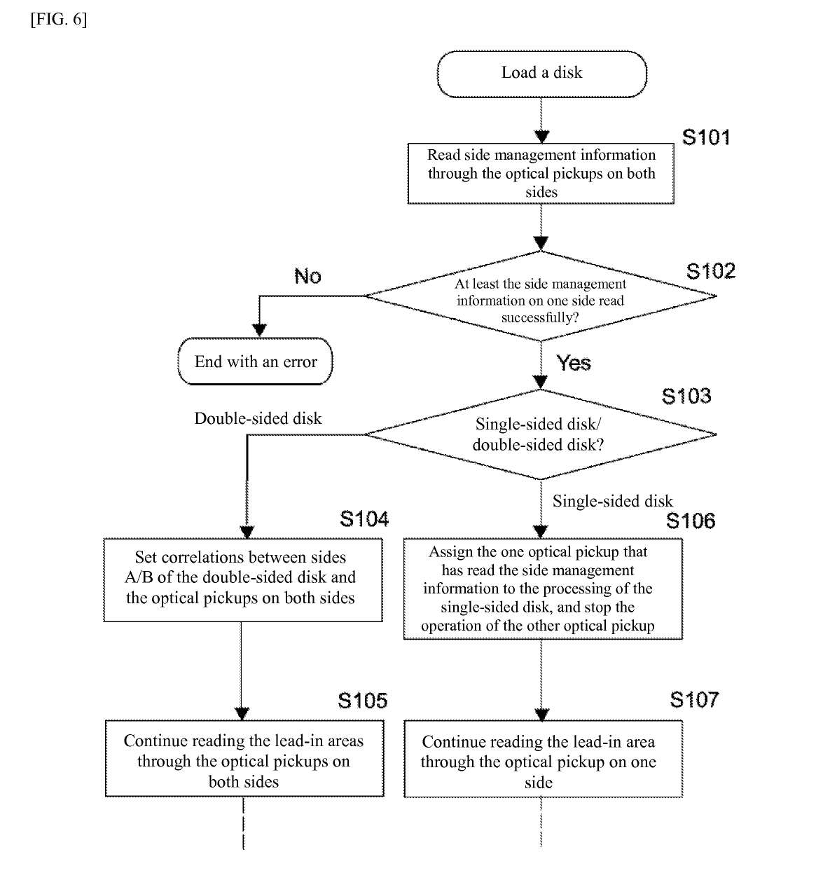

FIG. 6 is a flow chart showing a procedure according to which the disk drive 31 performs control based on face-management information.

After the optical disk 11 has been loaded into the disk drive 31 in the drive unit 30, the controller 81 moves the optical pickups 32 on both sides to positions at which they can read the lead-in areas of the optical disk 11, to try reading the face-management information from the lead-in areas of the guide layers 112 on both sides (Step S101).

Here, if the loaded optical disk 11 is a double-sided disk, then the management information that includes the face-management information (face-identification information) for identifying the sides (sides A/B) of the double-sided disk is played back by the management information playback part 78 from the signals that have been read by the optical pickups 32 on both sides, respectively, from the lead-in areas of the guide layers 112 of the corresponding optical disks with guide layer 111 (“Yes” in Step S102, “Double-sided disk” in Step S103).

The controller 81, based on the face-management information played back by the management information playback part 78, assigns for the processing on the top side (side A) of the double-sided disk the one optical pickup 32 that has read the face-management information indicating the top (side A) as the applicable side of the double-sided disk, while assigning for the processing on the bottom side (side B) the other pickup 32 that has read the face-management information indicating the bottom (side B) as the applicable side of the double-sided disk (Step 104). The above correlations between the respective sides of the double-sided disk on one hand, and the two optical pickups 32 on the other, will be retained in the controller 81 until the optical disk 11 is ejected from the disk drive 31.

Thereafter, the controller 81 performs control in such way that the optical pickups 32 on both sides are used to continue reading the lead-in areas of the guide layers 112 on both sides of the double-sided disk as well as the lead-in area of the target recording layer 113 (Step S105).

Next, the operation that takes place when a single-sided disk is loaded into the disk drive 31 is explained. In this case, in Step S102 the management information is read by either of the two optical pickups 32 from the lead-in area of the guide layer 12, and played back by the management information playback part 78 (“Yes” in Step S102). Here, the face-management information obtained from the lead-in area of the guide layer 112 of the single-sided disk is single-sided disk identification information (“Single-sided disk” in Step S103).

After determining that the face-management information included in the management information played back by the management information playback part 78 is single-sided disk identification information, the controller 81 assigns for the processing of the single-sided disk the one optical pickup 32 that has read the management information including this face-management information, and stops the operation of the other optical pickup 32 (Step S106). Here, stopping the operation of an optical pickup 32 means, for example, stopping the emission of guide light and recording/playback light from the optical pickup 32 and then causing the optical pickup to retreat to the specified standby position. Note that a single-sided disk is treated as side A of a double-sided disk, for example.

Thereafter, the controller 81 performs control in such way that the one optical pickup 32 corresponding to the single-sided disk is used to continue reading the lead-in area of the guide layer 112 of the single-sided disk as well as the lead-in area of the recording layer 113 (Step S107).

[Effects] 1. With the optical recording system 1 in this embodiment, the incidence of defects caused by failed reading of face-management information can be lowered by pre-recording to the guide layer 112 the face-management information for identifying the sides of a double-sided disk, compared to when face-management information is recorded to the recording layer 113 using pre-pits, etc. To be specific, an optical disk having face-management information recorded in each of its recording layers must be discarded as a defect if any one recording layer generates an error when its face-management information is being read. This means that the incidence of defects tends to increase as the number of stacked recording layers increases; however, such trend can be eliminated so long as face-management information is pre-recorded to the guide layer 112.

2. As mentioned above, when a single-sided disk has been loaded into the disk drive 31, the controller 81 determines, based on the face-management information read from the lead-in area of the guide layer 12 by either of the processing systems of two optical pickups 32, that a single-sided disk has been loaded. This way, determination of a single-sided disk can be performed more quickly and reliably compared to the method of determining a single-sided disk based on tracking lead-in failures and other errors, thereby shortening the time after a single-sided disk is loaded until recording of user data to the single-sided disk is actually started.

3. Furthermore, with the optical recording system 1 in this embodiment, the face-management information (sides A/B) can be utilized as index information when the data (files) recorded in the recording layers 113 of the optical disk 11 are archived (combined into a single file). The search efficiency is expected to improve because face-management information (side A or B) can be specified as a data (file) search condition.

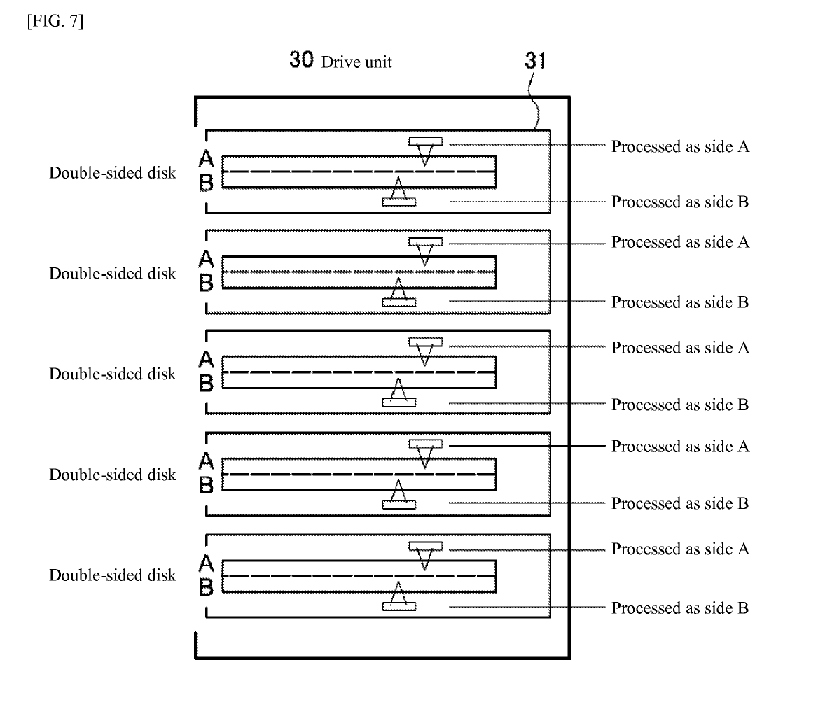

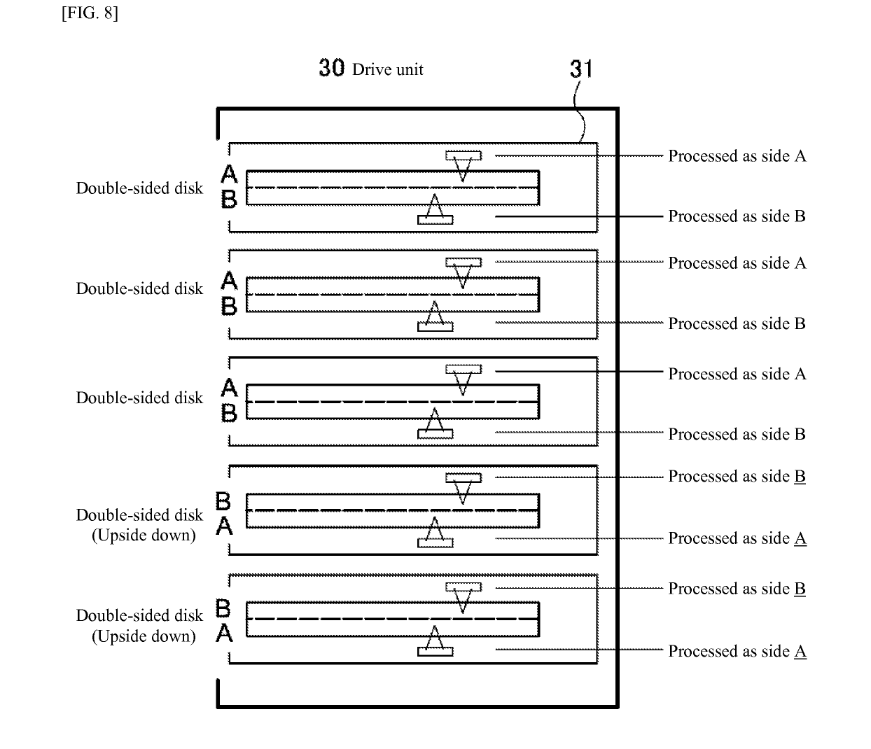

4. FIG. 7 shows a condition where optical disks 11 being double-sided disks are set, in the same orientation in terms of whether the top or bottom side (side A or B) faces up/down, in the respective disk drives 31 of the drive unit 30. Although this is the most typical condition, it is not a must with the optical recording system 1 in this embodiment. That is because, every time a double-sided disk is loaded, the controller 81 of the disk drive 31 sets as the processing system for the top (side A) the optical pickup 32 that has read the face-management information indicating the top (side A), and sets as the processing system for the bottom (side B) the optical pickup 32 that has read the face-management information indicating the bottom (side B). This means that, with the optical recording system 1 in this embodiment, when optical disks being double-sided disks are set in the drive unit 30, any limitation as to their orientation, or whether their top or bottom side faces up/down, can be eliminated, as shown in FIG. 8, for example.

[Disk Drive for Single-sided Disks] Next, the operation that takes place when the optical disk 11 in this embodiment is set in a disk drive for single-sided disks that are optical disks 11 having an optical pickup 32 provided only on one corresponding side, is explained.

In this case, the following three instances are expected: 1. A double-sided disk is set; 2. A single-sided disk is set correctly in terms of whether its top or bottom side is facing up/down; and 3. A single-sided disk is set upside down.

When a double-sided disk is set, the management information including the face-management information (face-identification information) for identifying the sides (sides A/B) of the double-sided disk is played back by the management information playback part 78 from the signals that have been read by the optical pickup 32 from the lead-in area of the corresponding guide layer 112 of the optical disk with guide layer 111. Accordingly, in this case the controller 81 assigns the optical pickup 32 and applicable side of the double-sided disk based on the face-management information played back by the management information playback part 78. To be specific, the controller 81 assigns the optical pickup 32 for the processing on the top side (side A) of the double-sided disk if the played-back face-management information represents face-identification information indicating the top (side A). If the played-back face-management information represents face-identification information indicating the bottom (side B), on the other hand, the controller 81 assigns the optical pickup 32 for the processing on the bottom side (side B) of the double-sided disk.

When a double-sided disk is set correctly in terms of whether its top or bottom side is facing up/down, the management information including the face-management information for identifying a single-sided disk (single-sided disk identification information) is played back by the management information playback part 78 from the signals that have been read by the optical pickup 32 from the lead-in area of the guide layer 112 of the optical disk with guide layer 111 that alone constitutes the single-sided disk. Accordingly, in this case the controller 81 directly assigns the optical pickup 32 for the processing of the single-sided disk based on the face-management information played back by the management information playback part 78.

When a single-sided disk is set upside down, the controller 81 determines a condition where a single-sided disk is set upside down, and consequently an error, because the optical pickup 32 fails to detect the very disk. After determining this error, the controller 81 relays it to the host device 50, for example, and the host device 50 alerts the user of the upside down error of the optical disk 11 according to this notification, for example. Or, if the disk transfer mechanism 20 has a function to turn over the optical disk 11, then the disk transfer mechanism 20 is instructed to turn over the optical disk 11.

It should be noted that the present invention is not limited to the aforementioned embodiment, but various changes can be made to the extent that they do not deviate from the key points of the present invention.

For example, while the face-management information is pre-recorded to the lead-in area of the guide layer by means of wobble modulation in the embodiment mentioned above, the face-management information may be pre-recorded to the lead-in area of the guide layer using pre-pits.

### DESCRIPTION OF THE SYMBOLS

1 - - - Optical recording system, 10 - - - Storage unit, 11 - - - Multi-layer optical recording medium, 30 - - - Drive unit, 31 - - - Disk drive, 32 - - - Optical pickup, 78 - - - Management information playback part, 80 - - - Feed mechanism, 81 - - - Controller, 111 - - - Optical disk with guide layer, 112 - - - Guide layer, 113 - - - Recording layer

1. A multi-layer optical recording medium in which:
two optical recording media with guide layers, each medium having multiple recording layers capable of recording information as well as a guide layer having guide tracks for tracking and a lead-in area where management information is pre-recorded along the guide tracks, are integrally attached together in a manner constituting a double-sided disk capable of recording information on both sides, and
the management information includes face-identification information for identifying sides of the double-sided disk.

2. An optical recording device capable of recording information to a multi-layer optical recording medium in which:
two optical recording media with guide layers, each medium having multiple recording layers capable of recording information as well as a guide layer having guide tracks for tracking and a lead-in area where management information is pre-recorded along the guide tracks, are integrally attached together in a manner constituting a double-sided disk capable of recording information on both sides, and
the management information includes face-identification information for identifying sides of the double-sided disk; said optical recording device comprising:
a first optical pickup provided in correspondence with one of the optical recording media with guide layers constituting the multi-layer optical recording medium, and having a first guide optical system that condenses a first guide light onto the guide layer of the one optical recording medium with guide layer and then receives a reflection of condensed light;
a second optical pickup provided in correspondence with another optical recording medium with guide layer constituting the multi-layer optical recording medium, and having a second guide optical system that condenses a second guide light onto the guide layer of the other optical recording medium with guide layer and then receives a reflection of condensed light;
a management information playback part that plays back based on the first guide light received by the first guide optical system, as first management information, the management information recorded in the guide layer of the one multi-layer recording medium with guide layer, and also plays back based on the second guide light received by the second guide optical system, as second management information, the management information recorded in the guide layer of the other multi-layer recording medium with guide layer; and
a control part that sets correlations between the first optical pickup and second optical pickup on one hand, and the sides of the double-sided disk on the other, based on the face-identification information included in the first management information and second management information, respectively, that have been played back.

3. An optical recording device according to claim 2, wherein the aforementioned multi-layer optical recording medium can be selectively set as either a first multi-layer optical recording medium, or a second multi-layer optical recording medium where the optical recording medium with guide layer is used alone as a single-sided disk capable of recording information to one side and the management information includes single-sided disk identification information for identifying the single-sided disk,
wherein the face-management information playback part is adapted to playback the management information based on the guide light received by one of the first optical pickup and second optical pickup, and the control part is adapted to stop an operation of the other optical pickup between the first optical pickup and second optical pickup based on the single-sided disk identification information included in the management information that has been played back, when the second multi-layer optical recording medium is set.

4. An optical recording device in which:
two optical recording media with guide layers, each medium having multiple recording layers capable of recording information as well as a guide layer having guide tracks for tracking and a lead-in area where management information is pre-recorded along the guide tracks, are integrally attached together in a manner constituting a double-sided disk capable of recording information to both sides,
wherein a first multi-layer optical recording medium where the management information includes the face-identification information for identifying sides of the double-sided disk, or a second multi-layer optical recording medium where the optical recording medium with guide layer is used alone as a single-sided disk capable of recording information to one side and the management information includes single-sided disk identification information for identifying the single-sided disk, can be selectively set; said optical recording device comprising:
an optical pickup having a guide optical system that condenses guide light onto the guide layer of the optical recording medium with guide layer corresponding to either the set first multi-layer optical recording medium or second multi-layer optical recording medium, and then receives a reflection of a condensed light;
a management information playback part that plays back the management information recorded in the guide layer of the multi-layer recording medium with guide layer, based on the guide light received by the guide optical system; and
a control part that, if it is determined based on the played-back management information that the double-sided disk has been set, sets correlation between the optical pickup and an applicable side of the double-sided disk based on the face-identification information included in the played-back management information, and, if playback of the management information fails, determines a condition where a single-sided disk is set upside down, and consequently an Error.
